(19) United States
(12) Patent Application Publication
(10) Pub. No.: US 2025/0166404 A1
(43) Pub. Date: May 22, 2025

(54) Devices and Methods for Enhancing Data Extraction from Images

(71) Applicant: FETCH REWARDS, LLC, Chicago, IL (US)

(72) Inventors: Boris Kogan, Bellevue, WA (US); Alec Gil Stashevsky, Pasadena, CA (US); Samuel David Corzine, Chicago, IL (US); Ellen Gaulding Light, Madison, WI (US); Chia-Ning Lee, Bellevue, WA (US); Krzysztof Gasienica-Bednarz, Homer Glen, IL (US); Qingxia Yu, Falls Church, VA (US); Rafael Iriya, Phoenix, AZ (US); Junjie Li, Bethesda, MD (US); Nikhil Anumulapalli, Chicago, IL (US); Melanie Riley, Madison, WI (US)

(21) Appl. No.: 18/513,125

(22) Filed: Nov. 17, 2023

(51) Int. Cl. G06V 30/19; G06F 40/295; G06V 10/82; G06V 30/262

(52) U.S. Cl. CPC G06V 30/1918; G06F 40/295; G06V 10/82; G06V 30/1916; G06V 30/274

(57) ABSTRACT

Systems and methods for enhancing trainable optical character recognition (OCR) performance are disclosed herein. An example method includes receiving, at an application executing on a user computing device communicatively coupled to a machine vision camera, an image captured by the machine vision camera, the image including an indicia encoding a payload and a character string. The example method also includes identifying the indicia and the character string; decoding the indicia to determine the payload; and applying an optical character recognition (OCR) algorithm to the image to interpret the character string and identify an unrecognized character within the character string. The example method also includes comparing the payload to the character string to validate the unrecognized character as corresponding to a known character included within the payload; and responsive to validating the unrecognized character, adding the unrecognized character to a font library referenced by the OCR algorithm.

### BACKGROUND

Machine vision systems have been rapidly adopted to suit many purposes. In tandem with their adoption, developers consistently attempt to increase and maximize their accuracy and overall utility. Visual document understanding may generally provide high fidelity image analysis but may also suffer from numerous issues. Namely, conventional visual document understanding systems typically suffer from a lack of accuracy when grouping and/or otherwise semantically linking objects (e.g., character strings) within images.

Thus, there is a need for devices and methods for enhancing data extraction from images that allow for fast, efficient, and accurate semantic linking.

### SUMMARY

In an embodiment, the present invention is a method for enhancing data extraction from images. The method may comprise: receiving an image including a plurality of character strings that each correspond to a respective unit; identifying, by execution of an optical character recognition (OCR) model, each of the plurality of character strings in the image; linking, by execution of a trained entity linking model, a portion of the plurality of character strings into one or more sets of linked character strings, wherein each character string included in a respective set of linked character strings corresponds to an identical respective unit; generating a structured object using the one or more sets of linked character strings; and causing a user computing device to display the structured object for viewing by a user.

In a variation of this embodiment, identifying each of the plurality of character strings in the image may further comprise: determining, by execution of a named entity recognition (NER) model, a semantic meaning for each character string identified by the OCR model; determining, based on the semantic meaning of each character string, the portion of the plurality of character strings that require semantic linking; and inputting the portion of the plurality of character strings into the trained entity linking model for semantic linking.

In a variation of this embodiment, generating the structured object may further comprise: validating, by execution of a data validation model, that (i) each character string included in a respective set of linked character strings corresponds to an identical respective unit and (ii) each character string not included in a respective set of linked character strings corresponds to a unique respective unit.

In another variation of this embodiment, the method may further comprise, prior to generating the structured object: receiving a subsequent image including a subsequent plurality of character strings that each correspond to a respective unit; identifying, by execution of the OCR model, each of the subsequent plurality of character strings in the subsequent image; linking, by execution of the trained entity linking model, a portion of the subsequent plurality of character strings into one or more sets of subsequently linked character strings, wherein each character string included in a respective set of subsequently linked character strings corresponds to an identical respective unit; merging the one or more sets of linked character strings with the one or more sets of subsequently linked character strings to generate a preliminary structured object; iteratively performing steps (a)-(d) until (i) an image threshold is reached or (ii) the user concludes image transmission; and generating the structured object using the preliminary structured object.

In yet another variation of this embodiment, linking the portion of the plurality of character strings into the one or more sets of linked character strings may further comprise: predicting, by execution of the trained entity linking model, links between character strings of the plurality of character strings; and identifying a first set of linked character strings where each character string in the first set of character strings is linked to every other character string in the first set of character strings.

In still another variation of this embodiment, generating the structured object may further comprise: receiving, a subsequent image including a subsequent plurality of character strings; linking, by execution of the trained entity linking model, a subsequent portion of a subsequent plurality of character strings from the subsequent image into one or more sets of subsequently linked character strings; analyzing the one or more sets of subsequently linked character strings and the one or more sets of linked character strings to determine a duplicate data set; removing the duplicate data set from the one or more sets of subsequently linked character strings to generate a reduced set of linked character strings; and generating the structured object using the one or more sets of linked character strings and the reduced set of linked character strings.

In yet another variation of this embodiment, the method may further comprise: extracting, using a trained supplemental ML model, supplemental data from the image that is different from the plurality of character strings, wherein the trained supplemental ML model is a non-OCR based model.

In still another variation of this embodiment, the trained entity linking model may be a graph neural network (GNN) trained to identify semantic links between character strings. Further in this variation, the method may further comprise: identifying, by a feedback model, an anomaly in the trained entity linking model; generating, by the feedback model, an adjustment recommendation for the trained entity linking model; and adjusting one or more outputs of the trained entity linking model based on the adjustment recommendation.

In yet another variation of this embodiment, the method may further comprise: validating, by a data enrichment model, the plurality of character strings based on data (i) stored in a central database or (ii) accessed through an external database; and enriching, by the data enrichment model, the plurality of character strings with additional data determined based on the plurality of character strings.

In still another variation of this embodiment, identifying each of the plurality of character strings in the image may further comprise: outputting, by the OCR model, the plurality of character strings with a corresponding two-dimensional (2D) location of each character string.

In yet another variation of this embodiment, the image may include a receipt, and the respective unit may correspond with a purchase unit.

In another embodiment, the present invention is a device for enhancing data extraction from images. The system may comprise: an imager configured to capture an image including a plurality of character strings that each correspond to a respective unit; one or more processors; and one or more memories storing computer-executable instructions thereon, that when executed by the one or more processors, may cause the one or more processors to: receive the image from the imager, identify, by execution of an optical character recognition (OCR) model, each of the plurality of character strings in the image, link, by execution of a trained entity linking model, a portion of the plurality of character strings into one or more sets of linked character strings, wherein each character string included in a respective set of linked character strings corresponds to an identical respective unit, generate a structured object using the one or more sets of linked character strings, and cause a user interface to display the structured object for viewing by a user.

In a variation of this embodiment, the computer-executable instructions, when executed by the one or more processors, may further cause the one or more processors to identify each of the plurality of character strings in the image by: determining, by execution of a named entity recognition (NER) model, a semantic meaning for each character string identified by the OCR model; determining, based on the semantic meaning of each character string, the portion of the plurality of character strings that require semantic linking; and inputting the portion of the plurality of character strings into the trained entity linking model for semantic linking.

In another variation of this embodiment, the computer-executable instructions, when executed by the one or more processors, may further cause the one or more processors to, prior to generating the structured object: receive a subsequent image including a subsequent plurality of character strings that each correspond to a respective unit; identify, by execution of the OCR model, each of the subsequent plurality of character strings in the subsequent image; link, by execution of the trained entity linking model, a portion of the subsequent plurality of character strings into one or more sets of subsequently linked character strings, wherein each character string included in a respective set of subsequently linked character strings corresponds to an identical respective unit; merge the one or more sets of linked character strings with the one or more sets of subsequently linked character strings to generate a preliminary structured object; iteratively perform steps (a)-(d) until (i) an image threshold is reached or (ii) the user concludes image transmission; and generate the structured object using the preliminary structured object.

In yet another variation of this embodiment, the computer-executable instructions, when executed by the one or more processors, may further cause the one or more processors to link the portion of the plurality of character strings into the one or more sets of linked character strings by: predicting, by execution of the trained entity linking model, links between character strings of the plurality of character strings; and identifying a first set of linked character strings where each character string in the first set of character strings is linked to every other character string in the first set of character strings.

In still another variation of this embodiment, the computer-executable instructions, when executed by the one or more processors, may further cause the one or more processors to generate the structured object by: receiving, a subsequent image including a subsequent plurality of character strings; linking, by execution of the trained entity linking model, a subsequent portion of a subsequent plurality of character strings from the subsequent image into one or more sets of subsequently linked character strings; analyzing the one or more sets of subsequently linked character strings and the one or more sets of linked character strings to determine a duplicate data set; removing the duplicate data set from the one or more sets of subsequently linked character strings to generate a reduced set of linked character strings; and generating the structured object using the one or more sets of linked character strings and the reduced set of linked character strings.

In yet another variation of this embodiment, the trained entity linking model may be a graph neural network (GNN) trained to identify semantic links between character strings, and the computer-executable instructions, when executed by the one or more processors, may further cause the one or more processors to: identify, by a feedback model, an anomaly in the trained entity linking model; generate, by the feedback model, an adjustment recommendation for the trained entity linking model; and adjust one or more outputs of the trained entity linking model based on the adjustment recommendation.

In still another variation of this embodiment, the computer-executable instructions, when executed by the one or more processors, may further cause the one or more processors to identify each of the plurality of character strings in the image by: outputting, by the OCR model, the plurality of character strings with a corresponding two-dimensional (2D) location of each character string.

In still another embodiment, the present invention is a tangible machine-readable medium comprising instructions that, when executed, may cause a machine to at least: receive an image including a plurality of character strings that each correspond to a respective unit; identify, by execution of an optical character recognition (OCR) model, each of the plurality of character strings in the image; link, by execution of a trained entity linking model, a portion of the plurality of character strings into one or more sets of linked character strings, wherein each character string included in a respective set of linked character strings corresponds to an identical respective unit; generate a structured object using the one or more sets of linked character strings; and cause a user computing device to display the structured object for viewing by a user.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is an example system for enhancing data extraction from images, in accordance with embodiments described herein.

FIG. 1B is another example system for enhancing data extraction from images, in accordance with embodiments described herein.

FIG. 2A is a flow diagram representing an example character string identification and semantic attribution process performed by the data extraction application of FIG. 1A, in accordance with embodiments described herein.

FIG. 2B is a flow diagram representing an example entity linking process performed by the data extraction application of FIG. 1A, in accordance with embodiments described herein.

FIG. 2C is a flow diagram representing an example end-to-end data extraction process performed by the data extraction application of FIG. 1A, in accordance with embodiments described herein.

FIG. 3 is a flowchart representative of a method for enhancing data extraction from images, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Visual document understanding system owners/operators have conventionally been plagued with inaccurate systems that fail to provide the recognition capabilities necessary to inform intricate data extraction. Namely, conventional visual document understanding systems struggle to accurately group and/or otherwise semantically link objects (e.g., character strings) within images. As a result, conventional OCR systems frequently return erroneous data and/or otherwise omit such high-fidelity data and thereby contribute to overall process inefficiency.

Thus, it is an objective of the present disclosure to eliminate these and other problems with conventional OCR systems by enabling enhanced data extraction from images using various models (e.g., ML/AI models). The devices and methods of the present disclosure thereby provide more accurate and efficient semantic linking of objects identified within images than conventional machine vision systems (e.g., conventional OCR systems). As described herein, the embodiments of the present disclosure may reduce the need for costly additional image captures, minimize the inaccurate identification and/or linking of semantically similar/linked objects within images, and generally ensure that the information extraction system maximizes image capture and processing efficiency and accuracy.

In accordance with the above, and with the disclosure herein, the present disclosure includes improvements in computer functionality or in improvements to other technologies at least because the disclosure describes that, e.g., a hosting device (e.g., user computing device), or otherwise computing device, is improved where the intelligence or predictive ability of the hosting device or computing device is enhanced by a trained machine learning model. These models, executing on the hosting device or user computing device, are able to accurately and efficiently identify and semantically link objects (e.g., character strings) represented in images. That is, the present disclosure describes improvements in the functioning of the computer itself or “any other technology or technical field” because a hosting device or user computing device, is enhanced with a trained machine learning model(s) to accurately identify and semantically link image objects in a manner configured to improve a user/operator's data extraction/interpretation efforts. This improves over the prior art at least because existing systems lack such identification and/or semantic linking functionality, and are generally unable to accurately analyze such image data on a real-time basis to output semantically linked objects designed to improve a user/operator's overall data extraction/interpretation efforts.

Moreover, the present disclosure includes improvements to the field of image-based data extraction. The machine learning models and architectures described herein provide real-time information extraction from physical images with speed, accuracy, and fidelity that was previously unachievable using conventional techniques. The hybrid, distributed, and modular nature of the techniques described herein enable devices/systems to understand complex, spatially conditioned semantic relationships (e.g., nested subitems, and other supplemental descriptors of purchase line-items) that conventional techniques were unable to understand. In particular, the techniques of the present disclosure incorporate both an OCR-based extraction system and a non-OCR based extraction system, which may also leverage generative AI transformer models. Such a hybrid engine leverages advantageous synergies between the two extraction systems to mitigate the downsides of both approaches. Additionally, the techniques of the present disclosure may incorporate a complex suite of rules-based, heuristic, and machine learning systems to mitigate against model errors and provide robust data validation against the output data. Thus, the techniques of the present disclosure improve the field of image-based data extraction at least by increasing the capabilities of the systems/devices in that field in the manners described above and herein.

As mentioned, the model(s) may be trained using machine learning and may utilize machine learning during operation. Therefore, in these instances, the techniques of the present disclosure may further include improvements in computer functionality or in improvements to other technologies at least because the disclosure describes such models being trained with a plurality of training data (e.g., 10,000s of training data corresponding to input images, character strings, etc.) to output the relevant semantically linked character strings configured to improve the user/operator's data extraction/interpretation efforts.

Moreover, the present disclosure includes effecting a transformation or reduction of a particular article to a different state or thing, e.g., transforming or reducing the processing demand of a data extraction system (and associated subsystems/components/devices) from a non-optimal or error state to an optimal state by eliminating erroneously identified objects within image data and/or erroneous semantic links between/among objects within image data.

Still further, the present disclosure includes specific features other than what is well-understood, routine, conventional activity in the field, or adding unconventional steps that demonstrate, in various embodiments, particular useful applications, e.g., identifying, by execution of an optical character recognition (OCR) model, each of the plurality of character strings in the image; linking, by execution of a trained entity linking model, a portion of the plurality of character strings into one or more sets of linked character strings, wherein each character string included in a respective set of linked character strings corresponds to an identical respective unit; generating a structured object using the one or more sets of linked character strings; and/or causing a user computing device to display the structured object for viewing by a user, among others.

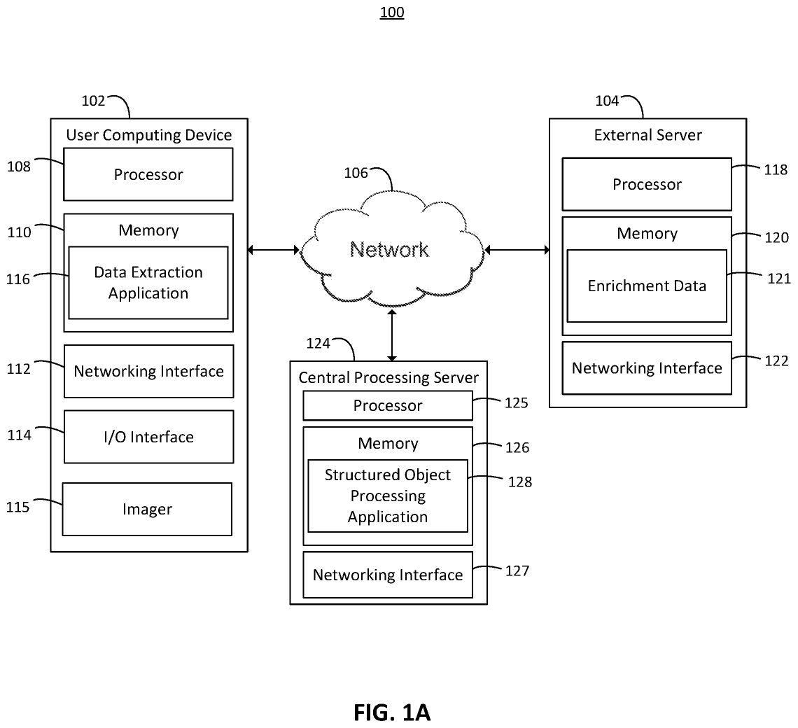

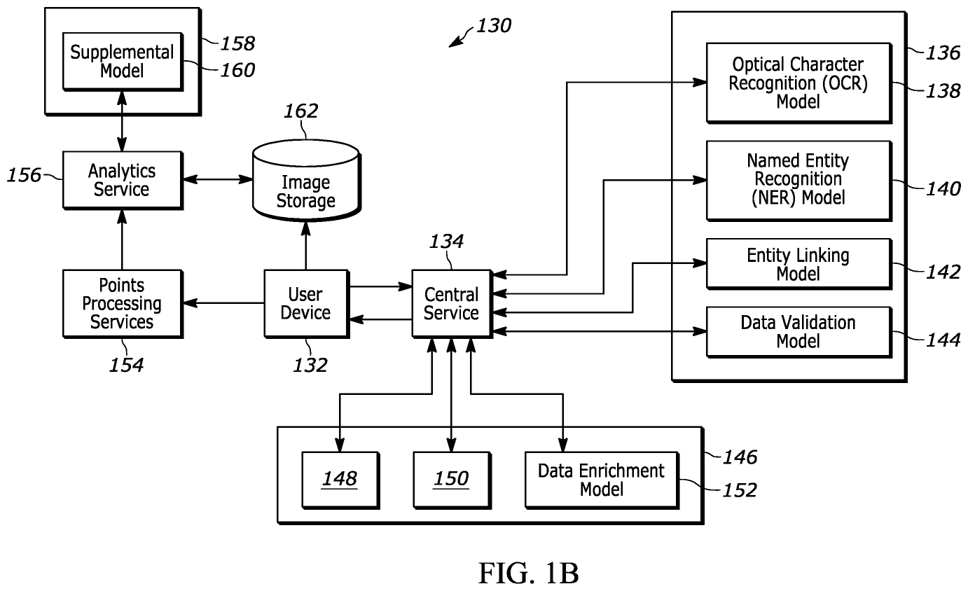

FIG. 1A illustrates an example system 100 for enhancing data extraction from images, in accordance with various embodiments disclosed herein. In the example embodiment of FIG. 1A, the example system 100 includes a user computing device 102, an external server 104, and a central processing server 124 communicatively coupled to the user computing device 102 and external server 104 via a network 106. Generally speaking, the user computing device 102, the central processing server 124, and the external server 104 may be capable of executing instructions to, for example, implement operations of the example methods described herein, as may be represented by the flowcharts of the drawings that accompany this description. Namely, the user computing device 102 may be connected to the external server 104, and the central processing server 124 via a network 106 and may generally be configured to interpret and process information captured and/or otherwise accessed or retrieved by the user computing device 102.

As an example, the user computing device 102 may obtain (e.g., across the network 106) and/or otherwise store in one or more memories 110 a job file containing one or more job scripts as part of the data extraction application 116 that may define a machine vision job and/or any suitable data extraction job and may configure the user computing device 102 to capture and/or analyze images in accordance with the machine vision job. The user computing device 102 may include flash memory used for determining, storing, or otherwise processing imaging data/datasets and/or post-imaging data. The user computing device 102 may then receive, recognize, and/or otherwise interpret a trigger that causes the user computing device 102 to capture an image (e.g., via imager 115) of a target object (e.g., a receipt) in accordance with the configuration established via the one or more job scripts stored as part of the data extraction application 116. Once captured and/or analyzed, the user computing device 102 may transmit the images and any associated data across the network 106 to the central processing server 124, the external server 104, and/or any other suitable location(s) for further analysis and/or storage. In various embodiments, the user computing device 102 may be or include a “smart” camera and/or may otherwise be configured to automatically perform sufficient functionality of the user computing device 102 in order to obtain, interpret, and execute job scripts that define machine vision jobs, such as any one or more job scripts contained in one or more job files as included in, for example, the data extraction application 116.

In any event, the user computing device 102 is generally configured to enable a user/operator to, for example, execute a machine vision job that may analyze and extract data from images captured by the imager 115. In certain embodiments, the user/operator may transmit/upload/input configuration adjustments, software updates, and/or any other suitable information to the user computing device 102 via the input/output (I/O) interface 114, where the information is then interpreted and processed accordingly. Regardless, the user computing device 102 may include one or more processors 108, one or more memories 110, a networking interface 112, the I/O interface 114, an imager 115, and a data extraction application 116.

Generally, the data extraction application 116 may include and/or otherwise comprise executable instructions (e.g., via the one or more processors 108) that allow a user to configure a machine vision job and/or imaging settings of the imager 115. For example, the data extraction application 116 may render a graphical user interface (GUI) on a display (e.g., I/O interface 114) of the user computing device 102, and the user may interact with the GUI to change various settings, modify machine vision jobs, input data, etc. Moreover, the data extraction application 116 may output results of the executed machine vision job for display to the user, and the user may again interact with the GUI to approve the results, modify imaging settings to re-perform the machine vision job, and/or any other suitable input or combinations thereof.

The data extraction application 116 may also include and/or otherwise comprise executable instructions (e.g., via the one or more processors 108) that automatically perform OCR and various other document AI techniques on images captured by the imager 115 and generate a structured object that includes one or more semantically linked character strings. For example, a receipt may include various sets/groupings of character strings (e.g., alphanumeric characters) printed thereon representing purchased units (e.g., purchased goods at a retail location). The one or more processors 108 may execute an OCR model, included as part of the data extraction application 116, to identify/interpret some/all of the character strings printed on the receipt. The one or more processors 108 may also execute an NER model, included as part of the data extraction application 116, to determine a semantic meaning for each character string identified by the OCR model. The one or more processors 108 may also execute a trained entity linking model, included as part of the data extraction application 116, to link at least a portion of the character strings into sets of linked character strings. The one or more processors 108 may also generate a structured object using the sets of linked character strings and cause the user computing device 102 to display (e.g., via I/O interface 114) the structured object for viewing by a user of the device 102.

Expanding on the prior example, a user of the user computing device 102 may desire to extract data from an image of a receipt that represents recent purchases made by the user. To that end, the user may capture an image of the receipt via the imager 115 of the user computing device 102. The one or more processors 108 may then execute instructions corresponding to an OCR model included as part of the data extraction application 116 to perform OCR on the image of the receipt and identify six character strings. These six character strings may include two character strings indicating a quantity of the purchased items (e.g., “1”, “2”, “5”), two character strings indicating a type of the purchased items (e.g., “hand soap”, “milk”), and two character strings indicating a price of the purchased items (e.g., “$3.50”, “$6.85”).

The one or more processors 108 may then execute instructions corresponding to a trained entity linking model included as part of the data extraction application 116 to perform entity linking on the six identified character strings, and thereby link the six character strings into two sets of linked character strings. Namely, the trained entity linking model may identify semantic links between a first quantity of purchased items (e.g., “1”), a first type of purchased items (e.g., “hand soap”), and a first price of purchased items (e.g., “$3.50); and the trained entity linking model may identify semantic links between a second quantity of purchased items (e.g., “3”), a second type of purchased items (e.g., “milk”), and a second price of purchased items (e.g., “$10.35”). As a result, the trained entity linking model may output a first set of linked character strings and a second set of linked character strings, where each character string in the first set corresponds to an identical purchased item(s)/unit(s) (e.g., one bottle of hand soap for $3.50) and each character string in the second set corresponds to an identical purchased item(s)/unit(s) (e.g., three gallons of milk for $10.35).

Generally, the trained entity linking model may be trained using training character strings to output training sets of linked character strings. In certain embodiments, the trained entity linking model may be a graph neural network (GNN) trained to identify semantic links between character strings. However, it should be appreciated that the trained entity linking model, and/or any other model or AI/ML-based application, module, or other instructions described herein may be trained and/or implemented using any suitable AI/ML technique or combinations thereof.

More generally, and in some embodiments, the user computing device 102 or other computing device may be configured to implement machine learning, such that the data extraction application 116 “learns” to analyze, organize, and/or process data without being explicitly programmed. Machine learning may be implemented through machine learning methods and algorithms. In one exemplary embodiment, a machine learning module may be configured to implement machine learning methods and algorithms (e.g., by training the data extraction application 116 and/or models included therein).

In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning.

In one embodiment, the data extraction application 116 employs supervised learning, which involves identifying patterns in existing data to make predictions about subsequently received data. Specifically, the data extraction application 116 and models included therein may be “trained” using training data, which includes example inputs and associated example outputs. Based upon the training data, the data extraction application 116 may generate a predictive function which maps outputs to inputs and may utilize the predictive function to generate machine learning outputs based upon data inputs. The exemplary inputs and exemplary outputs of the training data may include any of the data inputs or machine learning outputs described herein. In the exemplary embodiment, a processing element may be trained by providing it with a large sample of data with known characteristics or features.

In another embodiment, the data extraction application 116 may employ unsupervised learning, which involves finding meaningful relationships in unorganized data. Unlike supervised learning, unsupervised learning does not involve user-initiated training based upon example inputs with associated outputs. Rather, in unsupervised learning, the data extraction application 116 may organize unlabeled data according to a relationship determined by at least one machine learning method/algorithm employed by the data extraction application 116. Unorganized data may include any combination of data inputs and/or machine learning outputs as described herein.

In yet another embodiment, a data extraction application 116 may employ reinforcement learning, which involves optimizing outputs based upon feedback from a reward signal. Specifically, the data extraction application 116 may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

As an example, the data extraction application 116 may employ natural language processing (NLP) functions, which generally involves understanding verbal/written communications and generating responses to such communications. Moreover, the data extraction application 116 may include a generative ML/AI, such as a generative pre-trained transformer (GPT) model and/or any other suitable type of generative ML/AI model (e.g., large language model (LLM)) configured to generate responses based on training data corresponding to input images and/or other data described herein. The data extraction application 116 may be trained to perform such NLP/LLM functionality using a symbolic method, machine learning models, and/or any other suitable training method. As an example, the data extraction application 116 may be trained to perform at least two techniques that may enable the data extraction application 116 to understand words spoken/written by a user: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (PoS) tagging, parsing, lemmatization and stemming, stop-word removal, and/or any other suitable sub-task or combinations thereof. For example, using syntactic analysis, the data extraction application 116 may generate textual transcriptions from input images.

Semantic analysis generally involves analyzing text in order to understand and/or otherwise capture the meaning of the text. In particular, the data extraction application 116 applying semantic analysis may study the meaning of each individual word and/or character contained in a textual transcription in a process known as lexical semantics. Using these individual meanings, the data extraction application 116 may then examine various combinations characters included in an image to determine one or more contextual meanings of the characters/words. Semantic analysis may include one or more sub-tasks, such as word sense disambiguation, relationship extraction, sentiment analysis, and/or any other suitable sub-tasks or combinations thereof. For example, using semantic analysis, the data extraction application 116 may generate one or more semantic links between identified characters in image data based upon the textual transcriptions from a syntactic analysis.

After training, machine learning programs (or information generated by such machine learning programs) may be used to evaluate additional data. Such data may be and/or may be related to supplemental data extracted from the image, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset. Such trained machine learning programs may, therefore, be used to perform part or all of the analytical functions of the methods described elsewhere herein.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the data extraction application 116 may be used to output a structured object, and/or any other values, responses, or combinations thereof using artificial intelligence (e.g., machine learning model(s) of the data extraction application 116) or, in alternative aspects, without using artificial intelligence.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

In any event, when the trained entity linking model outputs the sets of linked character strings, the one or more processors 108 may then execute instructions included as part of the data extraction application 116 configured to generate a structured object using the sets of linked character strings. Broadly, the structured object may be or include the original image of the receipt with additional graphical overlays applied over and/or near the sets of linked character strings. The structured object may also include an underlying set of data corresponding to the sets of linked character strings that is structured in a predefined, computer-readable manner (e.g., JavaScript Object Notation (JSON) format). Thus, the one or more processors 108 may generate and display the structured object to a user by causing the user computing device 102 to display the image and graphical overlays for viewing by the user (e.g., via I/O interface 112) and by generating and transmitting the underlying set of data to a corresponding location (e.g., central processing server 124) for further interpretation/processing.

For example, the central processing server 124 may generally be configured to receive and process structured objects from the user computing device 102. The central processing server 124 may include one or more processors 125, one or more memories 126, a networking interface 127, and a structured object processing application 128 configured to receive the structured objects from the user computing device 102 and analyze/interpret the structured objects, in accordance with the predefined, computer-readable formatting. This analysis/interpretation may include, for example, determining whether the user of the user computing device 102 purchased certain types of items, certain quantities of items, and/or any other criteria that may be represented in the structured object sufficient to qualify for a benefit, discount, refund, and/or other suitable promotions or rewards as a result of the purchases represented by the structured object.

The data extraction application 116 may further include instructions causing the one or more processors 108 to determine, by execution of a named entity recognition (NER) model, a semantic meaning for each character string identified by the OCR model. The data extraction application 116 may also include instructions that cause the one or more processors 108 to determine, based on the semantic meaning of each character string, portion(s) of the identified character strings that require semantic linking. The data extraction application 116 may then also cause the one or more processors 108 to input the portion(s) of the identified character strings into the trained entity linking model for semantic linking.

In some embodiments, the data extraction application 116 may also include instructions that cause the one or more processors 108 to validate, by execution of a data validation model, that (i) each character string included in a respective set of linked character strings corresponds to an identical respective unit and (ii) that each character string not included in a respective set of linked character strings corresponds to a unique respective unit.

To illustrate, the data extraction application 116 may execute the feedback model to determine that a first set of linked character strings includes a first character string that is erroneously included in the first set despite corresponding to a different unit than the other character strings included in the first set. In this example, the data extraction application 116 may remove the first character string from the first set and/or may place the first character string in a second set of linked character strings if the first character string corresponds to a respective unit that is identical to the corresponding unit of each character string in the second set. However, if the first character string corresponds to a unique respective unit (e.g., a unit to which no other character string corresponds), the first character string may be placed in no set of linked character strings. As an example, the feedback model may remove a date (e.g., Jan. 1, 2024) identified in an image of a receipt from a third set of linked character strings corresponding to a purchase of rice at a grocery store because the date does not semantically correspond to the rice purchase. Moreover, the date may correspond to a unique unit and may therefore not be placed in a set of linked character strings.

Further, the data extraction application 116 may include instructions causing the one or more processors 108 to receive a subsequent image including subsequent character strings that each correspond to a respective unit, and identify, by execution of the OCR model, each of the subsequent character strings in the subsequent image. Thereafter, the data extraction application 116 may include instructions causing the one or more processors to link, by execution of the trained entity linking model, a portion of the subsequent character strings into set(s) of subsequently linked character strings. Each character string included in a respective set of subsequently linked character strings may correspond to an identical respective unit. The data extraction application 116 may also include instructions causing the one or more processors 108 to merge the sets of linked character strings with the sets of subsequently linked character strings to generate a preliminary structured object and may iteratively perform these actions until (i) an image threshold is reached and/or (ii) the user concludes image transmission/capture to and/or via the user computing device 102 or other suitable device. The data extraction application 116 may also include instructions causing the one or more processors to generate the structured object using the preliminary structured object.

For example, the user may have a receipt that is physically large enough to require multiple image captures to include all purchased items. The user may capture a first image of the receipt that includes a first half of the purchased items, and the capture of a subsequent image of the receipt may include the second half of the purchased items. When the user has captured both images, the data extraction application 116 may perform the actions described herein to identify character strings, link the character strings into sets of linked character strings, and generate preliminary structured objects using the first image and the subsequent image. The data extraction application 116 may also prompt the user to indicate when the user has finished capturing images of the receipt, and the user may provide an input (e.g., clicking, tapping, swiping, gesturing, voice commands, haptic inputs, etc.) to the user computing device 102 indicating that the user has concluded image transmission/capture.

Accordingly, the data extraction application 116 may generate a final structured object using the two preliminary structured objects of the first and subsequent images. The final structured object may include a combination of the two preliminary structured objects, with any duplicate character strings/linked sets reduced to a single instance. For example, the first image may include a set of linked character strings at the bottom of the image corresponding to a first unit (e.g., purchase of chicken strips), and the subsequent image may include the same set of linked character strings at the top of the image. When the data extraction application 116 generates a structured object based on the two images, the application 116 may recognize that the set of linked character strings corresponding to the first unit is represented in both images and may therefore be removed from the preliminary structured object of either the first image or the subsequent image to prevent double-counting the set of linked character strings corresponding to the first unit in the final/aggregate structured object.

Similarly, the data extraction application 116 may further include instructions causing the one or more processors 108 to generate a structured object by receiving, a subsequent image including subsequent character strings, and linking, by execution of the trained entity linking model, a subsequent portion of the subsequent character strings from the subsequent image into sets of subsequently linked character strings. The instructions may further cause the one or more processors 108 to analyze the sets of subsequently linked character strings and the sets of linked character strings to determine a duplicate data set and remove the duplicate data set from the sets of subsequently linked character strings to generate a reduced set of linked character strings, as previously described. The instructions may further cause the one or more processors 108 to generate the structured object using the sets of linked character strings and the reduced set of linked character strings.

Moreover, the data extraction application 116 may include instructions causing the one or more processors 108 to link the character strings into the sets of linked character strings by predicting, by execution of the trained entity linking model, links between character strings of the plurality of character strings, and identifying a first set of linked character strings where each character string in the first set of character strings is linked to every other character string in the first set of character strings.

For example, a first character string indicating a purchased item (e.g., “bath mat”) may be linked with a second character string indicating a price of the purchased item (e.g., “$7.00”). The data extraction application 116, via the trained entity linking model, may decide to link the first character string and the second character string together because their similar positions and relative displacement within the image suggest an association between the two character strings, because the price indicated by the second character string is within a threshold or tolerance value of what the data extraction application 116 predicts a “bath mat” to cost, and/or for any other suitable reason or combinations thereof.

Further, the data extraction application 116, via the trained entity linking model, may utilize the relative spatial positioning/displacement of identified character strings (output by the OCR model) with the understanding and semantic meaning of each piece of text (output by the NER model) to link character strings. For example, the data extraction application 116 may determine that a first character string without any numbers is more likely to be a store name or a product description rather than a price or a total. Similarly, the data extraction application 116 may determine that a second character string consisting only of numbers and non-alphabetic characters is more likely to be a price, a total, or a telephone number rather than a store name or product description.

The data extraction application 116 may also include instructions causing the one or more processors 108 to extract, using a trained supplemental ML model, supplemental data from an image that is different from the character strings. For example, the trained supplemental ML model may be trained to recognize and extract information corresponding to portions of a receipt or other suitable object including a retail store location, date, time, uniform resource locator (URL) link, quick response (QR) code, barcode, and/or other objects that may be included and/or otherwise represented in the image. Such supplemental data may be used in the generation of the structured object, transmitted to an external device (e.g., central processing server 124) with/without the structured object, and/or may be stored or transmitted in/to any suitable location by the user computing device 102.

The data extraction application 116 may also include instructions causing the one or more processors 108 to identify, by a feedback model, an anomaly in the trained entity linking model, and to generate, by the feedback model, an adjustment recommendation for the trained entity linking model. The instructions may further cause the one or more processors 108 to adjust one or more outputs of the trained entity linking model based on the adjustment recommendation.

For example, the trained entity linking model may output a set of linked character strings that includes an anomalous/erroneous entry. The feedback model may identify that the erroneous entry does not belong as part of the set of linked character strings because the entry does not correspond to the same respective unit as the other strings in the set. Additionally, or alternatively, the feedback model may receive user input indicating that the erroneous string is included in the set and should be removed. In either case, the feedback model may determine an adjustment to the output of the trained entity linking model (e.g., removing the erroneous entry from the set of linked character strings) to eliminate such an erroneous association between the character strings. The feedback model may then cause the one or more processors 108 to remove the erroneous entry from the set of linked character strings.

The data extraction application 116 may also include instructions causing the one or more processors 108 to validate, by a data enrichment model, the character strings based on data (i) stored in a central database or (ii) accessed through an external database and enrich the character strings with additional data determined based on the character strings. For example, the data enrichment model may cause the one or more processors 108 to access the external server 104 and the enrichment data 121 stored therein to determine whether any of the enrichment data 121 applies to the character strings identified and/or linked from a respective image representing a fast-food purchase at a first restaurant. The image of the receipt may not include and/or may not otherwise clearly indicate a store location for the first restaurant, so the data enrichment model may cause the one or more processors 108 to access the external server 104 to search for and/or otherwise retrieve a presumptive location for the first restaurant from the enrichment data 121. In certain embodiments, the external server 104 may be or include a web address, website, an Internet location, and/or any other suitable location or address to a location where the enrichment data 121 may be found.

Further, the data extraction application 116 may also include instructions causing the one or more processors 108 to identify each the character strings in an image by outputting, by the OCR model, the character strings with a corresponding two-dimensional (2D) location of each character string. For example, each image input to the data extraction application 116 may be analyzed on a pixel-by-pixel basis and/or any other suitable basis, and as a result, may be divided into a grid of N×Y locations, where N and Y may be any integer. A first image evaluated by the data extraction application 116 may have 1,000×1,000 locations, such that a first character string in the first image may have a set of corresponding 2D locations including all coordinates within the polygon defined by the lines extending between (150, 250), (150, 297), (185, 250), and (185, 297). Additionally, or alternatively, the data extraction application 116 may calculate and return an average 2D location for a character string and/or may utilize any suitable strategy to determine a 2D location for any particular character string.

The imager 115 may include a digital camera and/or digital video camera for capturing or taking digital images and/or frames. Each digital image may comprise pixel data that may be analyzed in accordance with instructions comprising the data extraction application 116, as executed by the one or more processors 108, as described herein. The digital camera and/or digital video camera of, e.g., the imager 115 may be configured to take, capture, or otherwise generate digital images and, at least in some embodiments, may store such images in a memory (e.g., one or more memories 110, 120, 126) of a respective device (e.g., user computing device 102, central processing server 124, external server 104). For example, the imager 115 may include a photo-realistic camera (not shown) for capturing, sensing, or scanning 2D image data. The photo-realistic camera may be an RGB (red, green, blue) based camera for capturing 2D images having RGB-based pixel data.

Each of the one or more memories 110, 120, 126 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., data extraction application 116 and/or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118, 125 (e.g., working in connection with the respective operating system in the one or more memories 110, 120, 126) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The one or more memories 110, 120, 126 may store an operating system (OS) (e.g., Microsoft Windows, Linux, Unix, etc.) capable of facilitating the functionalities, apps, methods, or other software as discussed herein. The one or more memories 110, 120, 126 may also store the data extraction application 116. The one or more memories 110, 120, 126 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine vision based imaging application, such as the data extraction application 116, where each may be configured to facilitate their various functionalities discussed herein. It should be appreciated that one or more other applications may be envisioned and that are executed by the one or more processors 108, 118, 125.

The one or more processors 108, 118, 125 may be connected to the one or more memories 110, 120, 126 via a computer bus responsible for transmitting electronic data, data packets, or otherwise electronic signals to and from the one or more processors 108, 118, 125 and one or more memories 110, 120, 126 in order to implement or perform the machine readable instructions, methods, processes, elements or limitations, as illustrated, depicted, or described for the various flowcharts, illustrations, diagrams, figures, and/or other disclosure herein.

The one or more processors 108, 118, 125 may interface with the one or more memories 110, 120, 126 via the computer bus to execute the operating system (OS). The one or more processors 108, 118, 125 may also interface with the one or more memories 110, 120, 126 via the computer bus to create, read, update, delete, or otherwise access or interact with the data stored in the one or more memories 110, 120, 126 and/or external databases (e.g., a relational database, such as Oracle, DB2, MySQL, or a NoSQL based database, such as MongoDB). The data stored in the one or more memories 110, 120, 126 and/or an external database may include all or part of any of the data or information described herein, including, for example, structured objects (e.g., a result of the data extraction application 116) and/or other suitable information.

The networking interfaces 112, 122, 127 may be configured to communicate (e.g., send and receive) data via one or more external/network port(s) to one or more networks or local terminals, such as network 106, described herein. In some embodiments, networking interfaces 112, 122, 127 may include a client-server platform technology such as ASP.NET, Java J2EE, Ruby on Rails, Node.js, a web service or online API, responsive for receiving and responding to electronic requests. The networking interfaces 112, 122, 127 may implement the client-server platform technology that may interact, via the computer bus, with the one or more memories 110, 120, 126 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122, 127 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, network 106 may comprise a private network or local area network (LAN). Additionally, or alternatively, network 106 may comprise a public network such as the Internet. In some embodiments, the network 106 may comprise routers, wireless switches, or other such wireless connection points communicating to the user computing device 102 (via the networking interface 112), the central processing server 124 (via networking interface 127), and the external server 104 (via networking interface 122) via wireless communications based on any one or more of various wireless standards, including by non-limiting example, IEEE 802.11a/b/c/g (WIFI), the BLUETOOTH standard, or the like.

The I/O interface 114 may include or implement operator interfaces configured to present information to an administrator or operator and/or receive inputs from the administrator or operator. An operator interface may provide a display screen (e.g., via the user computing device 102) which a user/operator may use to visualize any images, graphics, text, data, features, pixels, and/or other suitable visualizations or information. For example, the user computing device 102 may comprise, implement, have access to, render, or otherwise expose, at least in part, a graphical user interface (GUI) for displaying images, graphics, text, data, features, pixels, and/or other suitable visualizations or information on the display screen. The I/O interface 114 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the user computing device 102. According to some embodiments, an administrator or user/operator may access the user computing device 102 to initiate imaging setting calibration, review images or other information, make changes, input responses and/or selections, and/or perform other functions.

As described above herein, in some embodiments, the user computing device 102, the external server 104, the central processing server 124, and/or other components described herein may perform the functionalities as discussed herein as part of a “cloud” network or may otherwise communicate with other hardware or software components within the cloud to send, retrieve, or otherwise analyze data or information described herein.

FIG. 1B is another example system 130 for enhancing data extraction from images, in accordance with embodiments described herein. Generally speaking, the example system 130 may be built under a microservice architecture design with a single orchestration service (e.g., the central service 134), which may be responsible for receiving and emitting initial inputs and final outputs of the data extraction process. The example system 130 may receive images as input (e.g., receipt images) uploaded by a user, and the central service 134 may then be responsible for sending the images and subsequent outputs through a series of machine-learning and rules-based components (e.g., first information extraction arm 136) which may extract information from the images in a structured, computer-readable form. The central service 134 may also be responsible for aggregating information across multiple images in cases where, e.g., a receipt is too long to be represented in a single image. When an image is first received by the central service 134, the image may be sent to a hybrid system consisting of the first information extraction arm 136, a second information extraction arm 158, and/or a data enrichment arm 146.

However, prior to transmitting the image data to any of the hybrid system arms 136, 146, 158, the central service 134 and/or other suitable service(s) may perform pre-processing on the image data. For example, the central service 134 may receive image data and may proceed to compress or resizing the image data, filter text strings included as part of the image data, perform feature normalization and/or engineering, and/or remove certain characters identifiable within the image data (e.g., special characters such as “&”, “<”, “>”, “@”, etc.). Of course, any/all of these actions may be performed before, during, and/or after the image data is transmitted and/or otherwise analyzed by any of the three hybrid system arms 136, 146, 158.

As mentioned, the example system 130 may utilize multiple machine learning models that may be interconnected in serial, parallel, and/or any other suitable configurations or combinations thereof. As a result, the example system 130 may reduce p99 latency by approximately 50% and cumulative accuracy improvements of over 200% relative to conventional techniques. In particular, the robust and flexible entity linking components (e.g., entity linking model 142) provide improvements over conventional systems by accommodating complex, nested, and arbitrarily dense implicit semantic linkage structures present in visually-rich document images, such as receipts and their associated line items.

In any event, the central server 134 may receive an image and send the image payload to an OCR model 138, which may extract character strings (e.g., pieces of text) and corresponding locations relative to the image. The OCR model 138 may output a collection/sets of character strings and 2D locations, which may be returned to the central service 134 and forwarded to the NER model 140. The NER model 140 may attribute semantic meaning to each character string extracted by the OCR model 138 and return the semantic meanings to the central service 134. The central service 134 may also identify character strings which may need to be semantically linked as a subset of the total extracted information.

The payload received from the NER model 140 containing character strings needing semantic linkage may then be sent to entity linking (EL) model 142. The EL model 142 may link associated character strings into collections/sets which semantically describe a same/identical unit (e.g., purchase line-item, such as prices, descriptions, coupons, discounts, quantities, unit prices, etc.). Thus, each set of linked character strings output by the EL model 142 may include character strings that all describe the same/identical unit on the input image. As previously mentioned, the EL model 142 and/or any other model described herein may be, include, and/or otherwise utilize a GNN and/or any other suitable ML techniques. The EL model 142 may return the sets of linked character strings to the central service 134, which may forward the sets of linked character strings to the data validation model 144. The data validation model 144 may perform a series of data validation and cleaning logic on the unlinked and semantically linked character strings and may combine all the data represented on an image to return a structured object to the central service 134.

Each of these actions described above in reference to the first information extraction arm 136 may be iteratively performed any suitable number of times until each image submitted in a single scan session and/or otherwise submitted by a user are processed by the first information extraction arm 136. When all images in a scan session and/or otherwise provided by a user are processed by the first information extraction arm 136, the central service 134 may then merge the information output by the first information extraction arm 136 by, for example, removing duplicate information to create a single structured object from multiple input images. Of course, in instances where only a single image is input to the central service 134, no merging may be performed. Regardless, the central service 134 may then return the structured object for display to a user, storage in memory, transmission to an external device/service, and/or for any other suitable purposes.

Further, the merging performed by the central service 134 may generally include merging any identified character strings within the image data. This may include merging character strings that are linked by the functions of the first information extraction arm 136 (e.g., the trained entity linking model 142) as well as character strings that are not linked to other character strings. For example, the first information extraction arm 136 may analyze a set of image data and identify/link a set of linked character strings including purchases of various units at a retail location, and the arm 136 and/or other arm (e.g., 158) may identify a set of unlinked character strings including a store name and address of the retail location. The central service 134 may receive these linked/unlinked character strings and proceed to merge the information by removing duplicate instances of the linked and/or the unlinked character strings to create the single structured object.

As mentioned, the central service 134 may also utilize the second information extraction arm 158, which may include a supplemental model 160. In certain embodiments, the supplemental model 160 (and, more broadly, the second information extraction arm 158) may be a non-OCR based ML model. When images submitted by the user are available, the central service 134 and/or the user device 132 may submit them to the second information extraction arm 158. These images may be identical to those processed by first information extraction arm 136. The user device 132 may generally be any suitable device, such as the user computing device 102 of FIG. 1A.

More specifically, the central server 134 and/or the user device 132 may transmit the images to a points processing service 154 and/or an image storage location 162. The points processing service 154 may then transmit an event notification to an analytics service 156, and the image storage 162 may transmit the image to the analytics service 156. The analytics service 156 may then submit and/or otherwise cause the supplemental model 160 to process the images, in accordance with the instructions contained therein. The supplemental model 160 may extract information from the image(s) in a structured manner directly from the images to supplement information gathered by the first information extraction arm 136.

For example, the supplemental model 160 may analyze an image to extract information such as transaction IDs and register IDs. Such supplemental information may serve a variety of purposes, such as implementing anti-fraud measures. To illustrate, a first user may submit images of multiple different receipts during a single day, and these receipts may indicate that the underlying transactions are being processed at the same register. Such a scenario may involve, for example, a cashier fraudulently submitting receipt images that are not reflective of purchases made by the cashier, and the supplemental model 160 may predictively indicate that the cashier should therefore not be rewarded and/or otherwise incentivized for submission of these images. The central service 134 and/or the user device 132 may then utilize these predictive indications from the supplemental model 160 to avoid rewarding and/or otherwise incentivizing such actions.

In certain instances, the images supplied by a user may not include and/or otherwise reliably indicate certain information that the central service 134 may utilize. For example, a user-submitted image of a receipt may not clearly indicate a store address, name, phone number, and/or other data corresponding to where the user's purchase took place. In such instances, the central service 134 may access and/or otherwise utilize the data enrichment arm 146 to enrich the data extracted from the images with relevant data.

The central service 134 may request and/or otherwise access a data enrichment model 152 configured to validate sets of character strings output from the first/second information extraction arm 136, 158 and to enrich the data included in the sets of character strings with additional data. The data enrichment model 152 may output recommendations to access data stored in a central/external database, predictions of what the additional data may be or include, and/or to enrich the data in the sets of character strings based on the content of the sets of character strings.

In particular, the data enrichment model 152 may be trained to identify numerous lexical variations corresponding to store names and/or other suitable character strings. The data enrichment model 152 may be trained to understand that these lexical variations may all semantically describe, for example, the same restaurant chain. When the data enrichment model 152 identifies the variation of the restaurant chain (or other character string(s)), the model 152 may further be trained to utilize/output a canonical character string to represent this chain. Accordingly, the data enrichment model 152 may identify any of the variational character strings as variations of the canonical character string.

For example, a user-submitted receipt may include a variational character string representing the store name (e.g., “Store X at Mall Y”, “Store X #45”, etc.), which may be evaluated by the data enrichment model 152. The data enrichment model 152 may recognize the variational character string and output a canonical character string representing the store name (e.g., “Store X”), and the processors executing the model 152 may proceed to enrich the data extracted from the user-submitted receipt in the first data extraction arm 136 with the canonical character string.

Additionally, or alternatively, the central service 134 may access the data enrichment arm 146 to retrieve/access the specific store name based on a phone number listed on the user-submitted receipt (block 150), and/or the central service 134 may retrieve/access the canonical store name using the general store name (block 148). These retrievals/accesses may be achieved through web-based databases/servers (e.g., a website corresponding to the general/canonical store name), through which, the central service 134 may retrieve more specific information corresponding to the user-submitted receipt to enrich the information extracted in the first/second information extraction arms 136, 158.

It should be appreciated that the devices and components described in reference to FIG. 1B may be included as part of any device and/or system described herein. For example, the example system 130 may be included and/or stored as part of the devices included in the example system 100 of FIG. 1A.

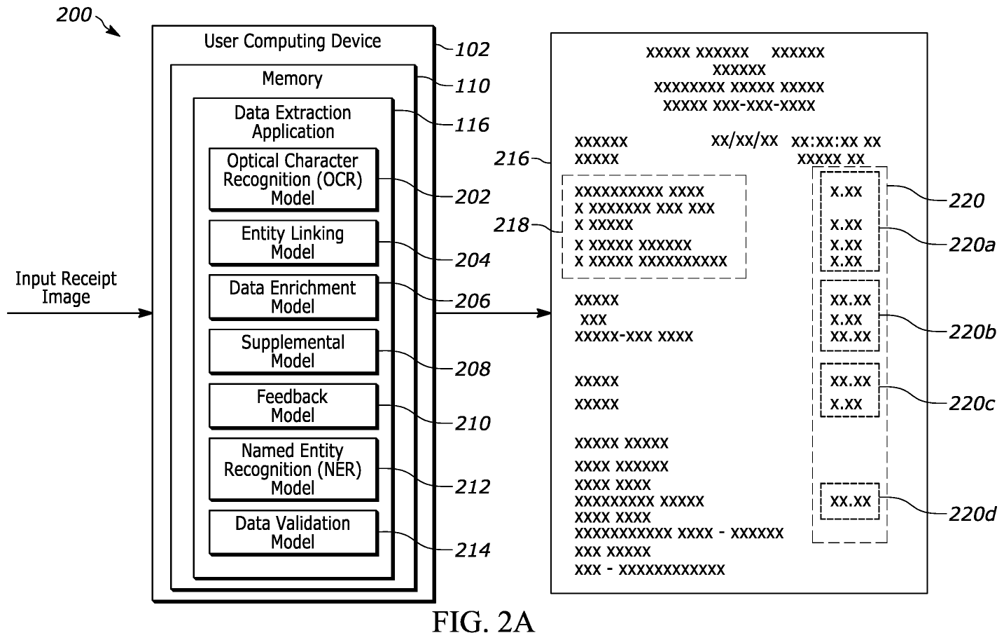

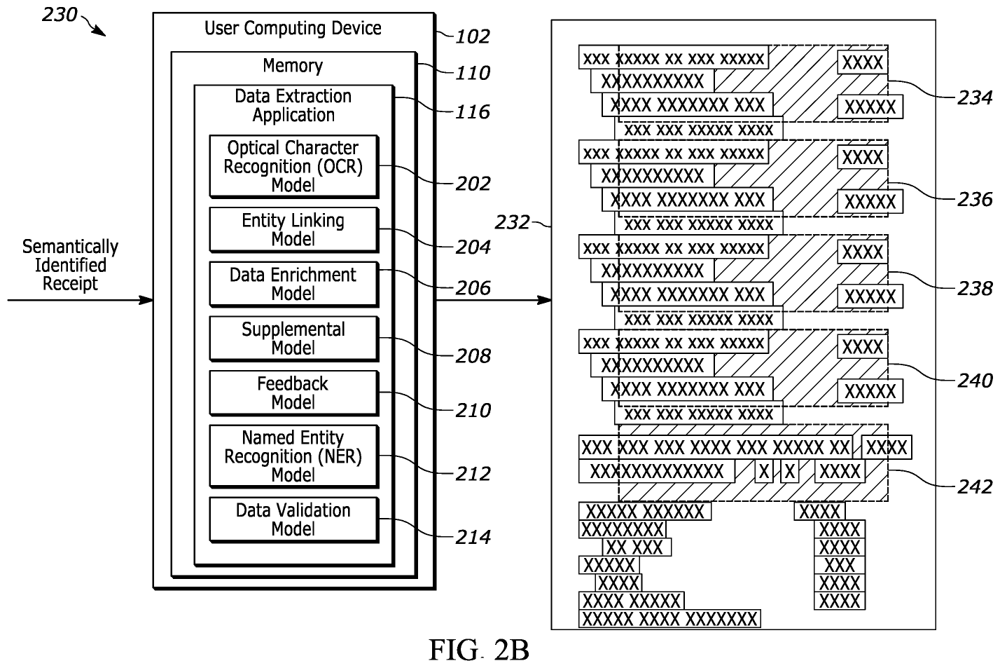

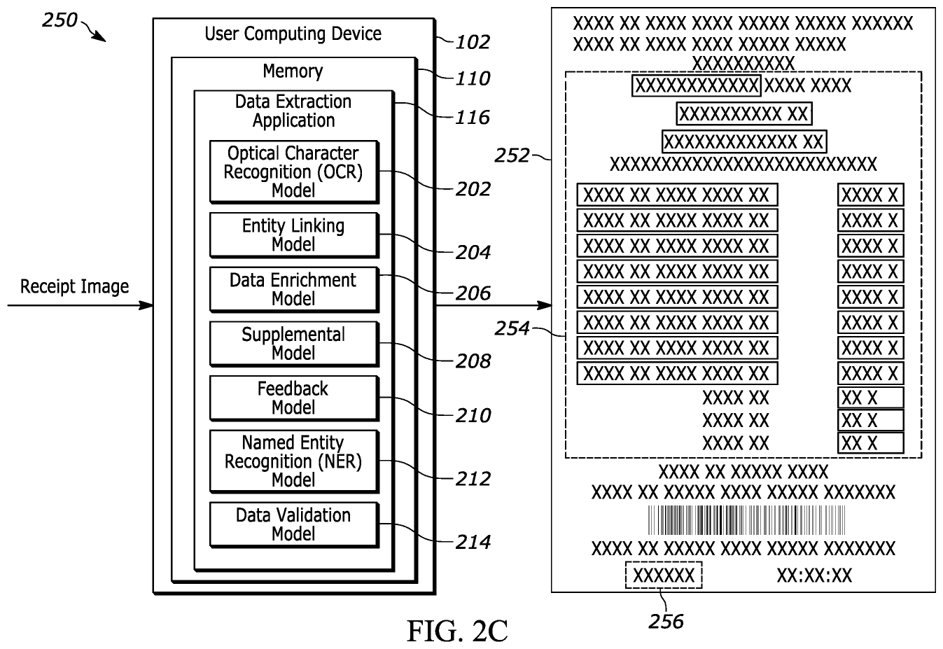

FIG. 2A is a flow diagram representing an example character string identification and semantic attribution process 200 performed by the data extraction application 116 of FIG. 1A, in accordance with embodiments described herein. The example character string identification and semantic attribution process 200 generally includes the user computing device 102 capturing, receiving, and/or otherwise accessing an input image (e.g., an input receipt image), the device 102 analyzing the input image using the data extraction application 116, and the device 102 outputting the annotated image 216. The annotated image 216 may include sets of localized character strings (e.g., 218, 220) output as a result of the input image being analyzed by the OCR model 202, and each of the sets of localized character strings 218, 220 may also have corresponding semantic attributions as a result of the sets of localized character strings 218, 220 being analyzed by the NER model 212.

As an example, the input receipt image may include a variety of food purchases at a fast food restaurant. As illustrated in the example character string identification and semantic attribution process 200 of FIG. 2A, the annotated image 216 may thereby include at least two sets of localized character strings 218, 220 that represent aspects of the food purchases. Namely, the first set of localized character strings 218 may represent a quantity and a type of each food purchase, and the second set of localized character strings 220 may represent prices of the food purchases.

Further, the OCR model 202 and the NER model 212 may identify and attribute semantic meanings to sub-groups of the sets of localized character strings 218, 220. Continuing the prior example, the second set of localized character strings 220 may include at least four sub-groups of localized character strings 220a, 220b, 220c, 220d, as identified by the OCR model 202 and/or the NER model 212. The first sub-group of localized character strings 202a may include an individual price for each purchase item in the first set of localized character strings 218. The second sub-group of localized character strings 202b may include a subtotal value, a tax amount, and a preliminary total based on the first sub-group of localized character strings 202a. The third sub-group of localized character strings 202c may include a cashless amount paid and a change value. The fourth sub-group of localized character strings 202d may include a total price value.

Thus, as illustrated by the example character string identification and semantic attribution process 200, the data extraction application 116 may analyze an input image to output any suitable number and/or groups of localized character strings (e.g., 218, 220, 220a-d) as represented by the input image. It should be understood that the annotated image 216 of FIG. 2A may include additional annotations not described herein, and that those annotations may be output by the data extraction application 116 (e.g., the OCR model 202 and/or the NER model 212) in an identical and/or similar manner, as described herein in reference to FIG. 2A and elsewhere herein.

FIG. 2B is a flow diagram representing an example entity linking process 230 performed by the data extraction application 116 of FIG. 1A, in accordance with embodiments described herein. The example entity linking process 230 generally includes the user computing device 102 receiving and/or otherwise accessing a semantically identified image (e.g., a semantically identified receipt), the device 102 analyzing the semantically identified image using the data extraction application 116, and the device 102 outputting the annotated image 232. The annotated image 232 may include sets of linked character strings (e.g., 234, 236, 238, 240, 242) output as a result of the input image being analyzed by the entity linking model 204. The semantically identified image may be input to the user computing device 102 as a result of the OCR model 202 and NER model 212 outputting such an semantically identified image, and input into the entity linking model 204 for analysis and generation of the annotated image 232.

More specifically, the entity linking model 204 may interpret each identified character string as a node on a graph. The entity linking model 204 may thereby link the identified character strings together into sets of linked character strings (e.g., 234-242) by predicting semantic links between these nodes, identifying individual connected components of the graph, and grouping these connected components together to form the sets of linked character strings. These semantic links between each of the character strings in the sets of linked character strings 234-242 may be illustrated in FIG. 2B by the patternings included in each of the sets of linked character strings 234-242.

As an example, the semantically identified image may include a variety of item purchases at a craft store. As illustrated in the example entity linking process 230 of FIG. 2B, the annotated image 232 may thereby include multiple sets of linked character strings 234-242 that represent aspects of the item purchases. Moreover, each set of linked character strings 234-242 may include character strings that each correspond to an identical item purchase or unit.

For example, the first set of linked character strings 234 may represent a quantity, a type, a price, a discount/deal, and/or a stock keeping unit (SKU) number for a purchase of a first candle. The second set of linked character strings 236 may represent a quantity, a type, a price, a discount/deal, and/or a SKU number for a purchase of a second candle. The third set of linked character strings 238 may represent a quantity, a type, a price, a discount/deal, and/or a SKU number for a purchase of a third candle. The fourth set of linked character strings 240 may represent a quantity, a type, a price, a discount/deal, and/or a SKU number for a purchase of a fourth candle. The fifth set of linked character strings 242 may represent a quantity, a type, a price, and/or a SKU number for a purchase of a first type of yarn.

In the prior example, the entity linking model 204 may receive the semantically identified image including each of the character strings mentioned in the sets of linked character strings 234-242. The entity linking model 204 may predict that each character string in the first set of linked character strings 234 correspond to the purchase of the first candle, and may therefore link each character string, as represented by the lines extending between each of the character strings in the first set of linked character strings 234. Similarly, the entity linking model 204 may predict that each character string in each of the second through fifth sets of linked character strings 236, 238, 240, 242 correspond to the respective purchases of the respective items. Accordingly, the entity linking model 204 may link each character string in those sets 236, 238, 240, 242, as represented by the lines extending between each of the character strings in the respective sets of linked character strings 236, 238, 240, 242.

FIG. 2C is a flow diagram representing an example end-to-end data extraction process 250 performed by the data extraction application 116 of FIG. 1A, in accordance with embodiments described herein. The example end-to-end data extraction process 250 generally includes the user computing device 102 receiving and/or otherwise accessing an input image (e.g., input receipt image), the device 102 analyzing the input image using the data extraction application 116, and the device 102 outputting the annotated image 252. The annotated image 252 may include sets of identified and extracted character strings (e.g., 254, 256) output as a result of the input image being analyzed by the supplemental model 208. The input image may be identical to the input images accessed and/or otherwise analyzed by the OCR model 202 and the NER model 212, as described in reference to FIG. 2A.

More specifically, the supplemental model 208 may independently perform data identification and/or extraction in a structured manner directly from the images to supplement information gathered by the OCR model 202, entity linking model 204, the NER model 212, and/or the data validation model 214. For example, the supplemental model 208 may analyze the input image to extract the information represented in the extracted character strings 254, 256, such as item purchase quantity, type, price, transaction ID, register ID, store phone number, transaction date/time, and/or or other suitable information or combinations thereof.

The supplemental model 208 may perform this data extraction in an end-to-end manner by utilizing generative ML/AI techniques to generate textual predictions of the character strings represented in the input image. For example, the supplemental model 208 may autoregressively generate text sequences (i.e., character strings) that are represented by the extracted character strings 254, 256 because the supplemental model 208 is trained to extract data in similar positions of input receipt images. The supplemental model 208 may utilize various transformer encoders/decoders to output these text sequences and may also identify the regions of the input image where such generated text sequences are located, as represented by the boxes within the extracted character strings 254, 256. In certain embodiments, the supplemental model 208 may be trained using and/or may be or include a document understanding transformer and/or any other suitable generative ML/AI technique(s).

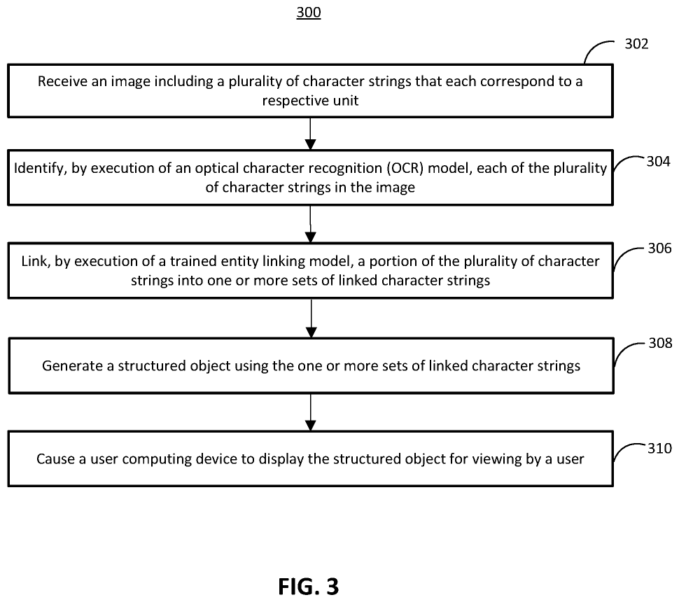

FIG. 3 is a flowchart representative of a method 300 for enhancing data extraction from images, in accordance with embodiments described herein. Generally, and as mentioned above, the method 300 for data extraction from images utilizes captured image data to identify character strings therein, and thereafter determines semantically linked sets of character strings. More specifically, the method 300 enables a user computing device (e.g., user computing device 102) and/or another suitable device (e.g., central processing server 124, external server 104) to extract data from images in a manner that was previously unachievable by conventional techniques. It is to be understood that any of the steps of the method 300 may be performed by, for example, the user computing device 102, the data extraction application 116, the central processing server 124, the one or more processors 108, 118, 125, and/or any other suitable components or combinations thereof discussed herein.

At block 302, the method 300 includes receiving an image including a plurality of character strings that each correspond to a respective unit (block 302). The method 300 may further include identifying, by execution of an OCR model, each of the plurality of character strings in the image (block 304). The method 300 may further include linking, by execution of a trained entity linking model, a portion of the plurality of character strings into one or more sets of linked character strings (block 306). Each character string included in a respective set of linked character strings may correspond to an identical respective unit. The method 300 may further include generating a structured object using the one or more sets of linked character strings (block 308). The method 300 may further include causing a user computing device to display the structured object for viewing by a user (block 310).

In certain embodiments, identifying each of the plurality of character strings in the image may further comprise: determining, by execution of an NER model, a semantic meaning for each character string identified by the OCR model; determining, based on the semantic meaning of each character string, the portion of the plurality of character strings that require semantic linking; and inputting the portion of the plurality of character strings into the trained entity linking model for semantic linking.

In some embodiments, generating the structured object may further comprise: validating, by execution of a data validation model, that (i) each character string included in a respective set of linked character strings corresponds to an identical respective unit and (ii) each character string not included in a respective set of linked character strings corresponds to a unique respective unit.

In certain embodiments, the method 300 may further comprise, prior to generating the structured object: receiving a subsequent image including a subsequent plurality of character strings that each correspond to a respective unit; identifying, by execution of the OCR model, each of the subsequent plurality of character strings in the subsequent image; linking, by execution of the trained entity linking model, a portion of the subsequent plurality of character strings into one or more sets of subsequently linked character strings, wherein each character string included in a respective set of subsequently linked character strings corresponds to an identical respective unit; merging the one or more sets of linked character strings with the one or more sets of subsequently linked character strings to generate a preliminary structured object; iteratively performing steps (a)-(d) until (i) an image threshold is reached or (ii) the user concludes image transmission; and generating the structured object using the preliminary structured object.

In some embodiments, linking the portion of the plurality of character strings into the one or more sets of linked character strings may further comprise: predicting, by execution of the trained entity linking model, links between character strings of the plurality of character strings; and identifying a first set of linked character strings where each character string in the first set of character strings is linked to every other character string in the first set of character strings.

In certain embodiments, generating the structured object may further comprise: receiving, a subsequent image including a subsequent plurality of character strings; linking, by execution of the trained entity linking model, a subsequent portion of a subsequent plurality of character strings from the subsequent image into one or more sets of subsequently linked character strings; analyzing the one or more sets of subsequently linked character strings and the one or more sets of linked character strings to determine a duplicate data set; removing the duplicate data set from the one or more sets of subsequently linked character strings to generate a reduced set of linked character strings; and generating the structured object using the one or more sets of linked character strings and the reduced set of linked character strings.

In some embodiments, the method 300 may further comprise: extracting, using a trained supplemental ML model, supplemental data from the image that is different from the plurality of character strings, wherein the trained supplemental ML model is a non-OCR based model.

In certain embodiments, the trained entity linking model may be a GNN trained to identify semantic links between character strings. Further in these embodiments, the method 300 may further comprise: identifying, by a feedback model, an anomaly in the trained entity linking model; generating, by the feedback model, an adjustment recommendation for the trained entity linking model; and adjusting one or more outputs of the trained entity linking model based on the adjustment recommendation.

In some embodiments, the method 300 may further comprise: validating, by a data enrichment model, the plurality of character strings based on data (i) stored in a central database or (ii) accessed through an external database; and enriching, by the data enrichment model, the plurality of character strings with additional data determined based on the plurality of character strings.

In certain embodiments, identifying each of the plurality of character strings in the image may further comprise: outputting, by the OCR model, the plurality of character strings with a corresponding two-dimensional (2D) location of each character string.

In some embodiments, the image may include a receipt, and the respective unit may correspond with a purchase unit.

Of course, it is to be appreciated that the actions of the method 300 may be performed any suitable number of times in any suitable order.

### ADDITIONAL CONSIDERATIONS

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions.

The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for enhancing data extraction from images, the method comprising:
receiving an image including a plurality of character strings that each correspond to a respective unit;
identifying, by execution of an optical character recognition (OCR) model, each of the plurality of character strings in the image;
linking, by execution of a trained entity linking model, a portion of the plurality of character strings into one or more sets of linked character strings, wherein each character string included in a respective set of linked character strings corresponds to an identical respective unit;
generating a structured object using the one or more sets of linked character strings; and
causing a user computing device to display the structured object for viewing by a user.

2. The method of claim 1, wherein identifying each of the plurality of character strings in the image further comprises:
determining, by execution of a named entity recognition (NER) model, a semantic meaning for each character string identified by the OCR model;
determining, based on the semantic meaning of each character string, the portion of the plurality of character strings that require semantic linking; and
inputting the portion of the plurality of character strings into the trained entity linking model for semantic linking.

3. The method of claim 1, wherein generating the structured object further comprises:
validating, by execution of a data validation model, that (i) each character string included in a respective set of linked character strings corresponds to an identical respective unit and (ii) each character string not included in a respective set of linked character strings corresponds to a unique respective unit.

4. The method of claim 1, further comprising, prior to generating the structured object:
(a) receiving a subsequent image including a subsequent plurality of character strings that each correspond to a respective unit;
(b) identifying, by execution of the OCR model, each of the subsequent plurality of character strings in the subsequent image;
(c) linking, by execution of the trained entity linking model, a portion of the subsequent plurality of character strings into one or more sets of subsequently linked character strings, wherein each character string included in a respective set of subsequently linked character strings corresponds to an identical respective unit;
(d) merging the one or more sets of linked character strings with the one or more sets of subsequently linked character strings to generate a preliminary structured object;
iteratively performing steps (a)-(d) until (i) an image threshold is reached or (ii) the user concludes image transmission; and
generating the structured object using the preliminary structured object.

5. The method of claim 1, wherein linking the portion of the plurality of character strings into the one or more sets of linked character strings further comprises:
predicting, by execution of the trained entity linking model, links between character strings of the plurality of character strings; and
identifying a first set of linked character strings where each character string in the first set of character strings is linked to every other character string in the first set of character strings.

6. The method of claim 1, wherein generating the structured object further comprises:
receiving, a subsequent image including a subsequent plurality of character strings;
linking, by execution of the trained entity linking model, a subsequent portion of a subsequent plurality of character strings from the subsequent image into one or more sets of subsequently linked character strings;
analyzing the one or more sets of subsequently linked character strings and the one or more sets of linked character strings to determine a duplicate data set;
removing the duplicate data set from the one or more sets of subsequently linked character strings to generate a reduced set of linked character strings; and
generating the structured object using the one or more sets of linked character strings and the reduced set of linked character strings.

7. The method of claim 1, further comprising:
extracting, using a trained supplemental ML model, supplemental data from the image that is different from the plurality of character strings, wherein the trained supplemental ML model is a non-OCR based model.

8. The method of claim 1, wherein the trained entity linking model is a graph neural network (GNN) trained to identify semantic links between character strings.

9. The method of claim 8, further comprising:
identifying, by a feedback model, an anomaly in the trained entity linking model;
generating, by the feedback model, an adjustment recommendation for the trained entity linking model; and
adjusting one or more outputs of the trained entity linking model based on the adjustment recommendation.

10. The method of claim 1, further comprising:
validating, by a data enrichment model, the plurality of character strings based on data (i) stored in a central database or (ii) accessed through an external database; and
enriching, by the data enrichment model, the plurality of character strings with additional data determined based on the plurality of character strings.

11. The method of claim 1, wherein identifying each of the plurality of character strings in the image further comprises:
outputting, by the OCR model, the plurality of character strings with a corresponding two-dimensional (2D) location of each character string.

12. The method of claim 1, wherein the image includes a receipt, and the respective unit corresponds with a purchase unit.

13. A device for enhancing data extraction from images, the system comprising:
an imager configured to capture an image including a plurality of character strings that each correspond to a respective unit;
one or more processors; and
one or more memories storing computer-executable instructions thereon, that when executed by the one or more processors, cause the one or more processors to:
receive the image from the imager,
identify, by execution of an optical character recognition (OCR) model, each of the plurality of character strings in the image,
link, by execution of a trained entity linking model, a portion of the plurality of character strings into one or more sets of linked character strings, wherein each character string included in a respective set of linked character strings corresponds to an identical respective unit,
generate a structured object using the one or more sets of linked character strings, and
cause a user interface to display the structured object for viewing by a user.

14. The device of claim 13, wherein the computer-executable instructions, when executed by the one or more processors, further cause the one or more processors to identify each of the plurality of character strings in the image by:
determining, by execution of a named entity recognition (NER) model, a semantic meaning for each character string identified by the OCR model;
determining, based on the semantic meaning of each character string, the portion of the plurality of character strings that require semantic linking; and
inputting the portion of the plurality of character strings into the trained entity linking model for semantic linking.

15. The device of claim 13, wherein the computer-executable instructions, when executed by the one or more processors, further cause the one or more processors to, prior to generating the structured object:
(a) receive a subsequent image including a subsequent plurality of character strings that each correspond to a respective unit;
(b) identify, by execution of the OCR model, each of the subsequent plurality of character strings in the subsequent image;
(c) link, by execution of the trained entity linking model, a portion of the subsequent plurality of character strings into one or more sets of subsequently linked character strings, wherein each character string included in a respective set of subsequently linked character strings corresponds to an identical respective unit;
(d) merge the one or more sets of linked character strings with the one or more sets of subsequently linked character strings to generate a preliminary structured object;
iteratively perform steps (a)-(d) until (i) an image threshold is reached or (ii) the user concludes image transmission; and
generate the structured object using the preliminary structured object.

16. The device of claim 13, wherein the computer-executable instructions, when executed by the one or more processors, further cause the one or more processors to link the portion of the plurality of character strings into the one or more sets of linked character strings by:
predicting, by execution of the trained entity linking model, links between character strings of the plurality of character strings; and
identifying a first set of linked character strings where each character string in the first set of character strings is linked to every other character string in the first set of character strings.

17. The device of claim 13, wherein the computer-executable instructions, when executed by the one or more processors, further cause the one or more processors to generate the structured object by:
receiving, a subsequent image including a subsequent plurality of character strings;
linking, by execution of the trained entity linking model, a subsequent portion of a subsequent plurality of character strings from the subsequent image into one or more sets of subsequently linked character strings;
analyzing the one or more sets of subsequently linked character strings and the one or more sets of linked character strings to determine a duplicate data set;
removing the duplicate data set from the one or more sets of subsequently linked character strings to generate a reduced set of linked character strings; and
generating the structured object using the one or more sets of linked character strings and the reduced set of linked character strings.

18. The device of claim 13, wherein the trained entity linking model is a graph neural network (GNN) trained to identify semantic links between character strings, and the computer-executable instructions, when executed by the one or more processors, further cause the one or more processors to:
identify, by a feedback model, an anomaly in the trained entity linking model;
generate, by the feedback model, an adjustment recommendation for the trained entity linking model; and
adjust one or more outputs of the trained entity linking model based on the adjustment recommendation.

19. The device of claim 13, wherein the computer-executable instructions, when executed by the one or more processors, further cause the one or more processors to identify each of the plurality of character strings in the image by:
outputting, by the OCR model, the plurality of character strings with a corresponding two-dimensional (2D) location of each character string.

20. A tangible machine-readable medium comprising instructions that, when executed, cause a machine to at least:
receive an image including a plurality of character strings that each correspond to a respective unit;
identify, by execution of an optical character recognition (OCR) model, each of the plurality of character strings in the image;
link, by execution of a trained entity linking model, a portion of the plurality of character strings into one or more sets of linked character strings, wherein each character string included in a respective set of linked character strings corresponds to an identical respective unit;
generate a structured object using the one or more sets of linked character strings; and
cause a user computing device to display the structured object for viewing by a user.
